(19) United States
(12) Patent Application Publication
(10) Pub. No.: US 2002/0175222 A1
(43) Pub. Date: Nov. 28, 2002

(54) Transportable texture applicator

(76) Inventor: Lauren Jay Vaage, Davis, CA (US)

Correspondence Address: Bernhard Dreten, Es. & Associates, 300 Capitol Mall, Suite 1100, Sacramento, CA, 95914, US

(21) Appl. No.: 09/817,450

(22) Filed: Mar. 26, 2001

(51) Int. Cl. B05B 9/08

(52) U.S. Cl. 239/153; 239/152; 239/308; 239/325; 239/526

(57) ABSTRACT

The transportable texture sprayer is a tool comprised of a tank that is filled with a texture material through a large orifice at the top of the tank and sealed with a cover. A swiveling orifice integrated into the cover for the large drain orifice at the bottom end of the tank, accepts a hose as the passage for the material to the spray gun when the tank is pressurized. An air compressor supplies pressure to both the spray gun and the tank. An air line that links the compressor to one leg of a three way nipple mounted to the tank air inlet which also provides the air pressure for the tank by way of its connection to a second leg to the three way nipple. A short length of air line is connected at one end to air pressure regulator that is coupled to the spray gun, with the other end connected to a third leg of the three way nipple that allows the air pressure for the tank and the spray gun to be regulated separately. The lower end of the tank incorporates members for upright stability so contraption does not rest on lower assembled parts when not in use, also when the tank is upright, a handle incorporated at the upper end of the tank will provide assistance for positioning of the harness system to be employed on the operators back, enabling the texture applicator to become fully operational.

### FIELD OF THE INVENTION

My texture applicator relates to in particular, to portable texture sprayers that atomize texture materials onto a work surface.

### BACKGROUND OF THE INVENTION

Tools have been fashioned to convey texture materials through systems of differently arranged components in order to release the material with a stream of pressurized air utilized as a vehicle that transports and atomizes the material into particulates onto a work surface as a form of texture. However, these texture applicators of past designs can limit the average person from producing a sprayed on texture appearance on a large to small work surface area that would be considered structurally and esthetically acceptable when working alone in a manner considered safe, efficient, or cost effective.

Described in brief are four differently designed texture applicator types of past designs which qualify for comparison.

(1) A type of texture applicator that is mounted on a vehicle bed, or towed behind a vehicle as a trailer, are large, expensive, and complex. These machines are comprised of a large motorized hopper that mixes the texture material and pumps the material through a hose in length long enough to reach the work surface. Accompanying the entire length of the material hose, runs a compressed air line connected to an air compressor located with the hopper that atomizes the material onto the work surface.

Since the work surface is generally out of sight of the hopper, the material hose when filled needs additional persons to attend the hopper and to negotiate the material hose and the compressed air line around obstacles for the operator directing the spray of the material onto the work surface.

(2) A type of texture applicator used to manually atomize premixed texture materials onto a work surface, operate much like a garden pesticide sprayer, wherein the operator creates air pressure by forcefully pumping a piston with one hand, while the other hand grips the piston housing with attached material reservoir, and directs the spray of material onto the work surface.

These type of texture applicators are limited to smaller work surface areas because of their reservoir capacity, and the steady amount of physical exertion needed in providing a uniform texture appearance on the work surface.

(3) A type of texture applicator that has a reservoir referred to as a hopper mounted on top of a nozzle referred to as a spray gun, rely on gravity to introduce a premixed texture material into the spray gun. To atomize the material onto a work surface, the spray gun is linked to an air compressor with an air line that completes this design of the applicator.

While providing a relatively inexpensive tool that applies the material to a greater surface area, a less skilled operator will encounter encumbering factors that impede desired results as one hand actuates the spray gun trigger, the other hand braces the built-in hand grip on the hopper necessary to support and right the filled hopper, leaving no hand free to adjust the material flow controls located on the spray gun, and regulate air pressure, and to preform work related tasks. The rate this design can apply the material when the hopper is full, is 50% or less than that of applicators that use a motorized pump or air pressure to force the material into the spray gun, and further less when the spray is directed at an angle, offsetting the material stored in the hopper that creates downward pressure when directly over the material intake orifice for spray gun, also, spillage often occurs. Furthermore, when directing the spray at a ceiling, an angled coupler must be installed between the hopper and the spray gun for the flow of the material to continue into the spray gun for reasons stated in the preceding sentence.

(4) A type of texture applicator that has a standing hopper and motorized pump, or pressurized tank to contain a premixed texture material, forces the material through a hose connected to a spray gun that is linked with an air line to an air compressor to atomize the material onto a work surface. This system provides an operator a tool for applying texture materials to small and large surface areas in greater quantity and better control in directing spray. Included in this system are aspects that limit use and availability. Though portable by means of a wheeled dolly or a handle for carrying, these applicator systems are awkward and heavy for one person to lift without the added texture material. Work surface areas out of arms reach, means moving the hopper, or coupling more lengths of compressed air line and material hose together which requires more material to be added to the hopper, creating more overall weight to the system and more drag resistance to the operators movements. These systems are expensive to purchase and maintain, and because of their complexity, specialized parts, tools and technicians are often required, making in the field repairs difficult, or for lengthy delays. A machine of many involved parts is more difficult to thoroughly clean of remaining material, that when dry, can and break loose to clog the small spray tip orifice during operation.

### OBJECTS AND ADVANTAGES

My texture applicator will not inherit a majority of the limitations present in the past designs of texture applicators when utilizing a majority of their components into the new design. The objective and the advantages can be noted by comparison.

### BRIEF DESCRIPTION OF THE INVENTION

A backpack style texture applicator that spreads the texture material onto the work surface with air pressure.

### BRIEF DESCRIPTION OF DRAWINGS

The illustrations provided are to be used in tandem with the detailed description of this transportable texture applicator so construction of this tool is not limited to its inventor.

FIG. 1 is a perspective view of the texture applicator when in use.

FIG. 2 is a perspective view showing more detail of tank shape, texture material inlets and outlets, and air flow system.

FIG. 3 shows means for support when transporting, and not in use.

REFERENCE NUMERALS IN DRAWINGS

| | | | |
|---|---|---|---|
| 2 | tank | 4 | air compressor |
| 6 | primary air line | 8 | swivel orifice |
| 10 | material hose | 12 | spray gun |
| 14 | spray gun air line | 16 | top orifice cover |
| 18 | bottom orifice cover | 20 | tank air inlet |
| 22 | air shut off valve | 24 | three way nipple |
| 26 | handle | 28 | air pressure regulator |
| 30 | support members | 32 | shoulder straps |
| 34 | waist belt | 36 | back brace |

### DETAILED DESCRIPTION OF THE INVENTION

The drawings provided are of my, “Transportable Texture Applicator,” showing, are the primary parts of this invention and how they have been arranged using perspective illustrations so the viewer may understand the principles applied while not involving specific methods of connection between the primary components described. Nor is mentioned are the inventors preferred choices of material composition of the described components which might otherwise limit this contraption from being constructed with alternate materials for uses other than its title implies.

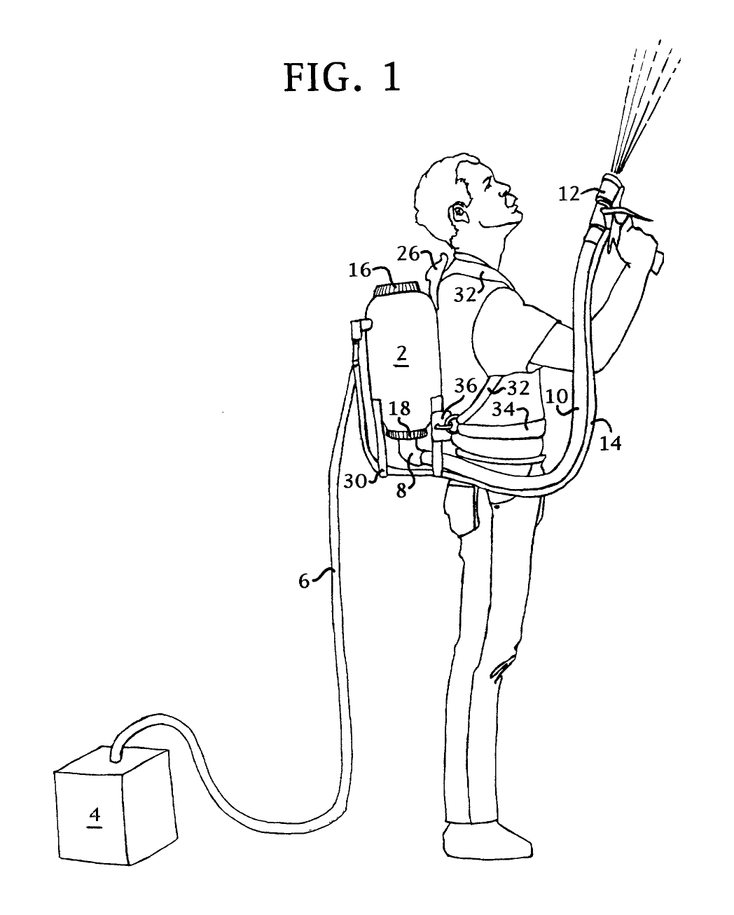

FIG. 1 demonstrates with a perspective view the transportable texture applicator in its operational position. A premixed texture compound referred to as the material that will be applied to a work surface, is held in a reservoir that is in essence a tank 2 designed to be carried upright upon an operators back by an attached harness system 32, 34, 36.

The tank 2 accepts the material through the top orifice and then sealed with a cover 16. With a primary air line 6 linking an air compressor 4 to the tank 2 air inlet, pressurized air is introduced which forces the material drown through a swiveling orifice 8 integrated into the tank 2 drain orifice cover 18, to which a material hose 10 has been coupled that allows the material to continue on to the spray gun 12 coupled to the hose 10 end.

For the material to reach a work surface in texture form, it must be broken down into particulates by introducing the material into a stream of pressurized air that also acts as the vehicle that scatters the material onto work the surface. This happens when the operator releases both material and air from the spray gun 12 tip together. Air pressure for both the tank 2 and the spray gun 12 is generated from the air compressor 4.

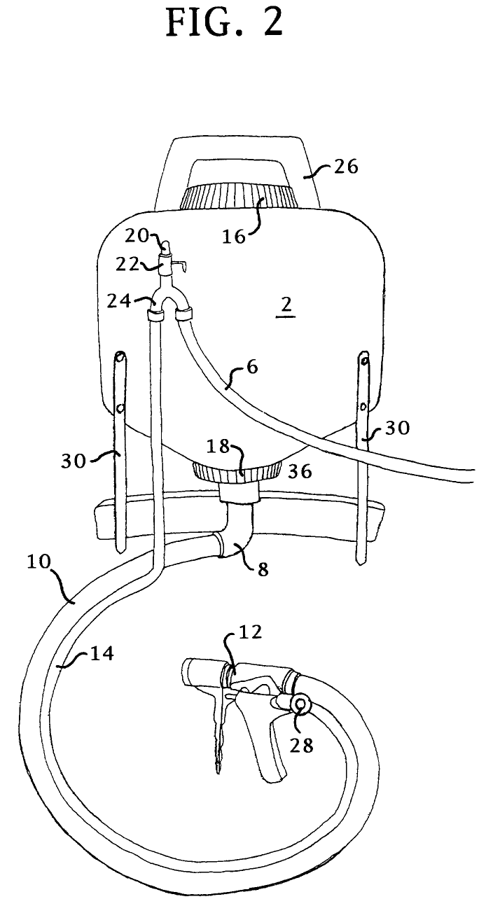

FIG. 2 further explains routing of air pressure supplied by the air compressor 4 in FIG. 1 to the tank 2 and the spray gun 12 sharing the primary air line 6. The primary air line 6 and the spray gun airline 14 are coupled at two legs of a three way nipple 24 creating a bypass, allowing constant air pressure to be maintained to the spray gun 12 that monitors its own pressure with an attached air pressure regulator 28. The spray gun air line 14 descends from the three way nipple 24 to streamline alongside the material hose 10 for better control in directing spray by alleviating entanglement between the material hose and air line. The third leg of the three way nipple 24 enters an air shut off valve 22 that is connected to the tank 2 air inlet 20.

The lower portion of the tank 2 is tapered for maximum material flow into the material hose 10. The material hose 10 needs to be no more in length than the operator's reach.

To aid thorough cleaning, the tank 2 is shaped with the outside corners tapered into the large filling orifice under the top cover 16, and the large bottom drain orifice when without cover 18.

Enabling the tank 2 to remain upright on ground for filling are supports 30 long enough to keep the tank 2 from resting on the the material hose 10 assembly at the bottom of the tank 2.

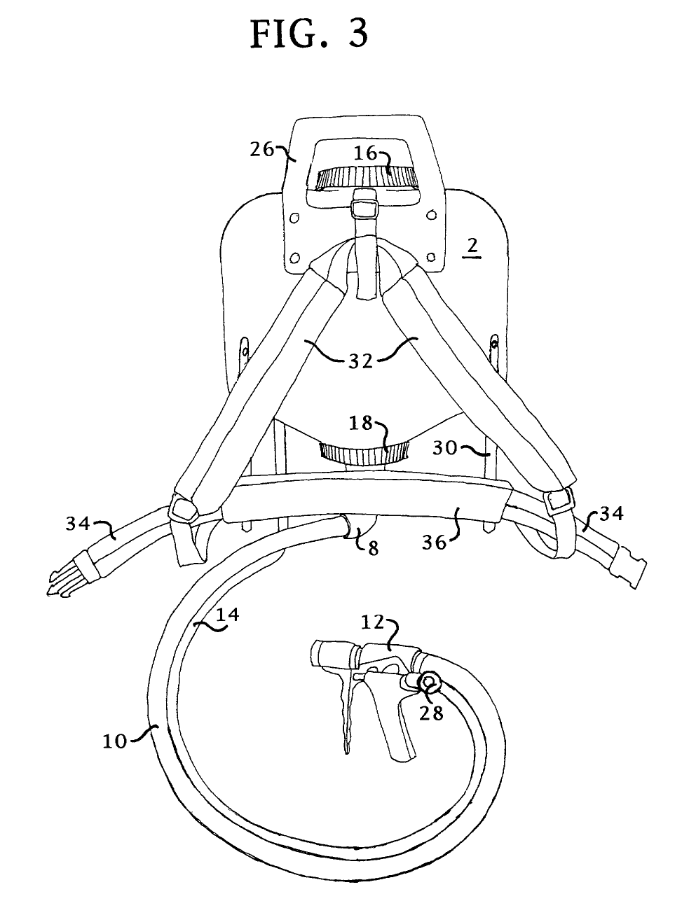

FIG. 3 illustrates a handle 26 for lifting the tank 2, and a typical harness system comprising of shoulder straps 32, a waist belt 34, and a back brace 36 that provide a system for attaching the contraption onto the back the operator while in operation.

I claim:

1. A contraption for applying texture materials onto a work surface, the contraption comprising: of
a tank modified to accept, contain, and be drained of the material, and maintain a regulated pressure during application of the material, and permit material level to be known.
a length of hose to transport texture materials from the tank to a spray gun.
an assembly of components arranged that distribute supplied air pressure to the tank and the spray gun.
support for upright stability of the contraption when not in use.
a handle for lifting the contraption.
a harness for supporting the contraption upon an operators back during use.

2. The contraption of claim 1, the tank further comprises: of
a large orifice at the top end and the bottom end; wherein
the top orifice and the bottom orifice will each have a sealable cover;
wherein
the bottom orifice cover will have integrated a swiveling orifice to which the hose of claim 1, that connects the tank to the spray gun will be approximately in length of the operator's reach.
the shape of tank will be tapered at the top end and the bottom end; and
the tank will permit material level to be known using a portal in tank hull
when tank hull is not comprised of a translucent material.

3. The contraption of claim 1 wherein the components that distribute supplied air pressure are comprised: of
a three way nipple that has one leg of the nipple connected to an air shut off valve that is connected to an air inlet orifice mounted to the tank, with the second leg of the nipple connected to the supplied air pressure line; wherein
the third leg of the nipple connects a length of air line long enough to descend down the tank to where it meets the material hose and streamlines alongside at length of the hose to be coupled with; a pressure regulator attached to the spray gun.

4. The contraption of claim 1 is further comprised of transporting support;
wherein
the members located at the lower portion of the tank keep the contraption balanced upright and off the swivel orifice connections when the harness is not in use; wherein
the handle located at upper portion of the tank is referred to when toting, and in assisting the operator in positioning contraption onto their back;
wherein
the typical harness system comprising of shoulder straps, a waist belt, and a back brace attach to the tank, enabling the contraption to be used fully as the texture material applicator.
